(19) United States
(12) Patent Application Publication
(10) Pub. No.: US 2002/0034583 A1
(43) Pub. Date: Mar. 21, 2002

(54) Method of preparing positive active material for a lithium secondary battery

(76) Inventor: Won-Il Jung, Cheonan-city (KR)

Correspondence Address: CHRISTIE, PARKER & HALE, LLP, P.O. BOX 7068, PASADENA, CA, 91109-7068, US

(21) Appl. No.: 09/882,351

(22) Filed: Jun. 15, 2001

(30) Foreign Application Priority Data
Jun. 16, 2000 (KR) 2000-33297

(51) Int. Cl. B05D 5/12

(52) U.S. Cl. 427/126.3

(57) ABSTRACT

A method of preparing a positive active material for a lithium secondary battery comprises preparing a coating solution by dissolving conductive polymer in solvent and coating lithium complex metal oxide with the coating solution. Accordingly, the present invention provides a method of coating conductive polymer on the surface of lithium complex metal oxides used as positive active material. With this method, it is easy to coat and evenly coat conductive polymer. The prepared positive active material has excellent electrochemical characteristics, particularly at elevated temperatures.

### CROSS REFERENCE TO RELATED APPLICATION

This application claims priority of application No. 2000-33297 filed in the Korean Industrial Property Office on Jun. 16, 2000, the content of which is incorporated hereinto by reference.

### FIELD OF THE INVENTION

The present invention relates to a method of preparing a positive active material for a lithium secondary battery, and more specifically, to a method of preparing a positive active material for a lithium secondary battery with excellent electrochemical characteristics.

### BACKGROUND OF THE INVENTION

A lithium secondary battery is prepared by using material that can be reversibly intercalated and deintercalated as positive and negative electrode active materials, and by charging an organic electrolyte or a polymer electrolyte placed between the positive electrode and the negative electrode. The lithium battery produces electric energy by an oxidation-reduction reaction when lithium ion is intercalated and deintercalated in the positive electrode and negative electrode.

The negative active material of lithium secondary battery is a carbon-based material and the positive active material is a chalcogenide compound, for example, a complex metal oxide such as LiCoO₂, LiMn₂O₄, LiNiO₂, LiNi₁₋ₓCoₓO₂(0<x<1), or LiMnO₂.

Recently, conductive polymers have been studied as new positive electrode active materials. However, when only a conductive polymer is used as a positive electrode active material, a deposition/stripping phenomenon occurs on the surface of the positive electrode, instead of an intercalation/deintercalation reaction that occurs during the charging/discharging mechanism of the lithium secondary battery. Thus, there is a problem that the specific capacity of a battery using a conductive polymer does not reach the theoretical capacity.

In order to solve the problem of using only a conductive polymer as a positive electrode active material, the use of conductive polymers with lithium complex metal oxide has been tested in new methods. One example of these methods is the preparation of core-shell typed positive active material comprising conductive polymer polymerized on the surface of lithium complex metal oxides. This method, however, is disadvantageous in that y-MnO₂, formed from modified complex metal oxide, specifically manganese active material, is oxidized during the polymerization, so that poor performance including poor initial capacity and unstable cycle characteristic occurs.

### SUMMARY OF THE INVENTION

The present invention is presented to solve these problems, and accordingly, it is an object of the present invention to provide a method of preparing a positive active material for a lithium secondary battery with excellent electrochemical characteristics.

It is another object of the present invention to provide a method of preparing a positive active material for a lithium secondary battery which has a good cycle life at high temperatures and no decrease in the volume of active material.

In order to achieve the objects, the present invention provides a method of preparing a positive active material for a lithium secondary battery which comprises preparing a coating solution by dissolving conductive polymer in solvent, and coating lithium complex metal oxide with the coating solution.

### BRIEF DESCRIPTION OF THE DRAWING

FIG. 1 is a graph showing the cycle lives of lithium secondary batteries comprising positive active material of the Examples and the Comparative Examples of the present invention at room temperature.

FIG. 2 is a graph showing the cycle lives of lithium secondary batteries comprising positive active material of the Examples and the Comparative Examples of the present invention at elevated temperature.

### DETAILED DESCRIPTION AND THE PREFERRED EMBODIMENTS

The present invention provides a method of coating the surface of lithium complex metal oxide used as positive active material for a lithium secondary battery with a conductive polymer in a liquid state. The first step of the present method is to prepare a coating solution by dissolving conductive polymer in a suitable solvent. The above conductive polymer is preferably polypyrrole, polyaniline, polythiophene, polyacetylene, a derivative thereof, or a mixture thereof. Examples of polythiophene include poly(3-butylthiophene-2,5-diyl), poly(3-hexylthiophene-2,5-diyl), poly(3-octylthiophene-2,5-diyl), poly(3-decylthiophene-2,5-diyl), poly(3-dodecylthiophene-2,5-diyl) and the like.

When classifying applicable conductive polymer according to the electric state, it can be classified into either the emeraldine base polymer or the polymer of doping state. The emeraldine base means the electrically neutral state of the polymer. The emeraldine base polymer can be prepared by polymerizing only monomers, or dedoping a doped polymer. Dedoping can be easily carried out by adding a material that is capable of reacting with the doping material of the doped polymer, and then washing the product to obtain the emeraldine base polymer. The above polymer of doping state is prepared by polymerizing monomers under a solution atmosphere diluted with doping material. In addition, it can be prepared by forming a polymer of emeraldine base state formed by dedoping a polymer of doping state, and then re-doping it with doping material. The polymer, which is subjected to doping, dedoping and re-doping, has improved electroconductivity and solubility. The polymer in doping state is electrically neutral as it loses electrons while bonding with doping material, so that it is charged with a positive charge (“+”), and it bonds with doping material charged with a negative charge (“−”). The doping material may include any material that can be charged with “−” by attracting electrons from the polymer. There is no limitation concerning the type of doping material. In addition, there is no limitation concerning the amount of doping material. Specific examples of doping material are lithium salts, such as lithium halide, and organic acids having a long alkyl chain. Examples of organic acids having a long alkyl chain are alkylbenzene sulfonic acids such as p-toluene sulfonic acid, benzene sulfonic acid, octylbenzene sulfonic acid, and dodecylbenzene sulfonic acid.

The polymers exemplified as conductive polymer can be used blended with other polymers such as polypyrrole or the polymer named as “polymer supported” (commercially available from the Aldrich company), comprising a conductive polypyrrole shell formed on a doped polyurethane core binder. They can be used in the form of a copolymer with polyurethane and polyvinylacetate. The kinds of polymers that can be blended or form copolymer with the conductive polymer are not limited to the above described polymers.

The conductive polymer used in the present invention has excellent electroconductivity and provides good adhesion between an active material or conductive material and a binder, as well as prevents thermal degradation of active material at elevated temperature. Particularly, when manganese active material is used, the conductive polymer can prevent thermal degradation and volume expansion of the material at elevated temperature.

The solvent used in preparing the coating solution can be an organic solvent, such as chloroform or m-cresol, or water, but it is not limited to these. There is no limitation if conductive polymer is dissolved in the solvent well.

According to the other preferred embodiment of the present invention, conductive agent or ionic conductive polymer can be added into the coating solution comprising the above conductive polymer. The conductive agent that can be used in the present invention includes graphite-based conductive agents, carbon-based conductive agents, and so on, but it is not limited to these. An example of a graphite-based conductive agent is KS 6 (product of Timcal company), and examples of carbon-based conductive agents are super P (product of MMM company), ketchen black, denka black, acetylene black, carbon black and so on. Examples of ionic conductive polymer that can be used in the present invention are polyethylene oxide, polypropylene oxide, polyethylene glycol, derivatives thereof, and mixtures thereof. It is possible to use a salt of the polymer, and a mixture of organic solvent with polymer or polymer salt.

The surface of the lithium complex metal oxide is coated with the prepared coating solution. In this case, it is preferable to use equipment that can evenly coat the conductive polymer on the surface of the lithium complex metal oxide to easily control the coating process. An example of such equipment is an agglomerator or a spray dryer, but any equipment can be used as long as it can coat the coating solution on the surface of oxide powders. When using the equipment, it is preferable to optimize the driving conditions such as the inlet amount, inlet temperature, fluidizing air volume, supplying rate of solution, revolution rate (RPM), air spray volume and so on, according to the equipment capacity.

The amount of coated conductive polymer is preferably 1 to 30 wt % on the basis of lithium metal oxide and more preferably 1 to 10 wt %. The amount of conductive material is preferably 0.1 to 10 wt % on the basis of lithium metal oxide, and the amount of ionic conductive polymer is preferably 0.1 to 5 wt %.

The thickness of the coating layer in the coated lithium complex metal oxide is preferably 0.1 to 1 μm . If the thickness is less than 0.1 μm, it cannot expect to improve the cycle life at elevated temperature, that is, the coating effect. On the contrary, if the thickness is more than 1 μm, initial capacity reduces as lithium ion is not smoothly intercalated or deintercalated into the metal oxides of the positive electrode.

The lithium complex metal oxide can include any lithium complex metal oxide which can be conventionally used in a lithium secondary battery. Examples are shown below in formulas 1 to 9, with formulas 1 to 4 being preferred.

formula 1: LiₓMn_{1-y}M′_{y}A₂

formula 2: LiₓMn_{1-y}M′_{y}O_{2-z}A_{z}

formula 3: LiₓMn₂O_{4-z}A_{z}

formula 4: LiₓMn_{2-y}M′_{y}A₄

formula 5: LiₓM_{1-y}M″_{y}A₂

formula 6: LiₓMO_{2-z}A_{z}

formula 7: LiₓNi_{1-y}Co_{y}O_{2-z}A_{z}

formula 8: LiₓNi_{1-y-z}Co_{y}M″_{z}Aα

formula 9: LiₓNi_{1-y-z}Mn_{y}M′_{z}Aα

(wherein, 0.95≦x≦1.1, 0≦y≦0.5, 0≦z≦0.5, 0 <α≦2, M is Ni or Co, M′ is at least one element selected from the group consisting of Al, Ni, Co, Cr, Fe, Mg, Sr, V, Sc, Y, La, Ce, Pr, Nd, Pm, Sm, Eu, Gd, Tb, Dy, Ho, Er, Tm, Yb, Lu, Ac, Th, Pa, U, Np, Pu, Am, Cm, Bk, Cf, Es, Fm, Md, No, and Lr, M″ is at least one element selected from the group consisting of Al, Cr, Mn, Fe, Mg, Sr, V, Sc, Y, La, Ce, Pr, Nd, Pm, Sm, Eu, Gd, Tb, Dy, Ho, Er, Tm, Yb, Lu, Ac, Th, Pa, U, Np, Pu, Am, Cm, Bk, Cf, Es, Fm, Md, No, and Lr, and A is selected from the group consisting of O, F, S and P.)

The present invention is further explained in more detail with reference to the following examples. These examples, however, should not in any sense be interpreted as limiting the scope of the present invention.

### EXAMPLES

### Example 1

A coating solution was prepared by dissolving a polypyrrole/polyurethane blend of doping state in pure water. LiMn₂O₄ coated with polypyrrole/polyurethane was prepared by adding the prepared coating solution and LiMn₂O₄ into an agglomerator. The content of polypyrrole/polyurethane was 1 wt % on the basis of the LiMn₂O₄.

### Example 2

A coating solution was prepared by dissolving a polyaniline of doping state in chloroform. LiMn₂O₄ coated with polyaniline was prepared by adding the prepared coating solution and LiMn₂O₄ into an agglomerator. The content of polyaniline was 1 wt% on the basis of the LiMn₂O₄.

### Example 3

A coating solution was prepared by dissolving a polyaniline of emeraldine base state in chloroform. LiMnO₂ coated with polyaniline was prepared by adding the prepared coating solution and LiMnO₂ into a spray dryer. The content of polyaniline was 1 wt% on the basis of the LiMnO₂.

### Example 4

A coating solution was prepared by dissolving redoped polyaniline with dodecylbenzene sulfonic acid and Super P (product of MMM company) in m-cresol. LiMn₂O₄ coated with polyaniline and Super P was prepared by adding the prepared coating solution and LiMn₂O₄ into an agglomerator. The respective contents of polyaniline and Super P were 1 wt % on the basis of the LiMn₂O₄.

### Example 5

A coating solution was prepared by dissolving redoped polyaniline with dodecylbenzene sulfonic acid, Super P (product of MMM company) and polyethylene oxide in m-cresol. LiMn₂O₄ coated with polyaniline, Super P, and polyethtylene oxide was prepared by adding the prepared coating solution and LiMn₂O₄ into an agglomerator. The respective contents of polyaniline, Super P and polyethylene oxide were 1 wt % on the basis of the LiMn₂O₄.

### Comparative Example 1

Positive active material for a lithium secondary battery was prepared by polymerizing pyrrole monomer on the surface LiMn₂O₄.

### Comparative Example 2

LiMn₂O₄ was used as a positive active material for a lithium secondary battery.

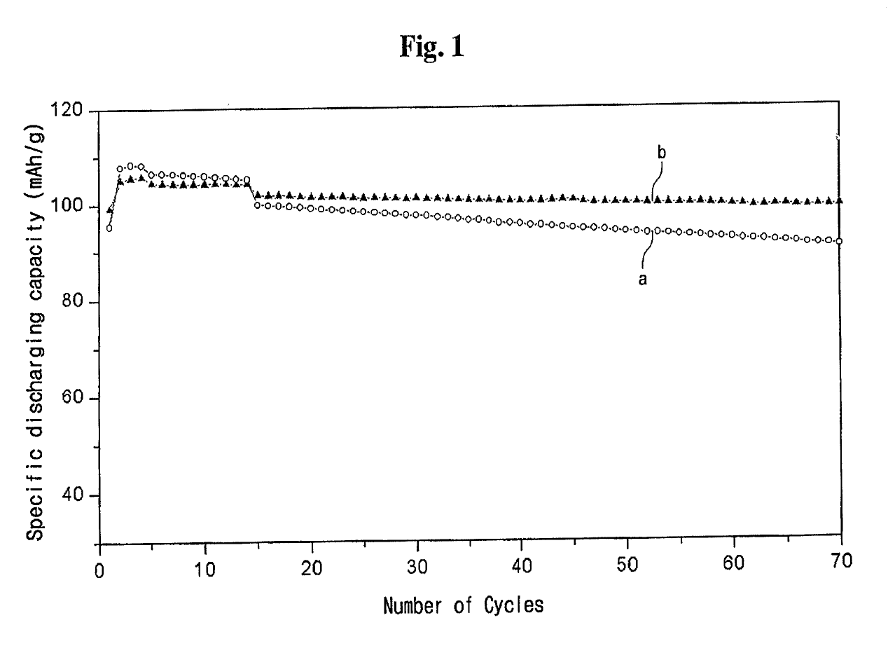

Lithium secondary coin cells were prepared by using positive active materials prepared according to the Examples 1 to 5 and Comparative Examples 1 and 2. The cycle life characteristics of coin cells comprising the positive active material of Example 1 and Comparative Example 2 at room temperature were measured and are shown in FIG. 1. As can be seen from FIG. 1, battery (b) using the positive active material of Example 1 has better life characteristic than battery (a) using the positive active material of Comparative Example 2 at room temperature.

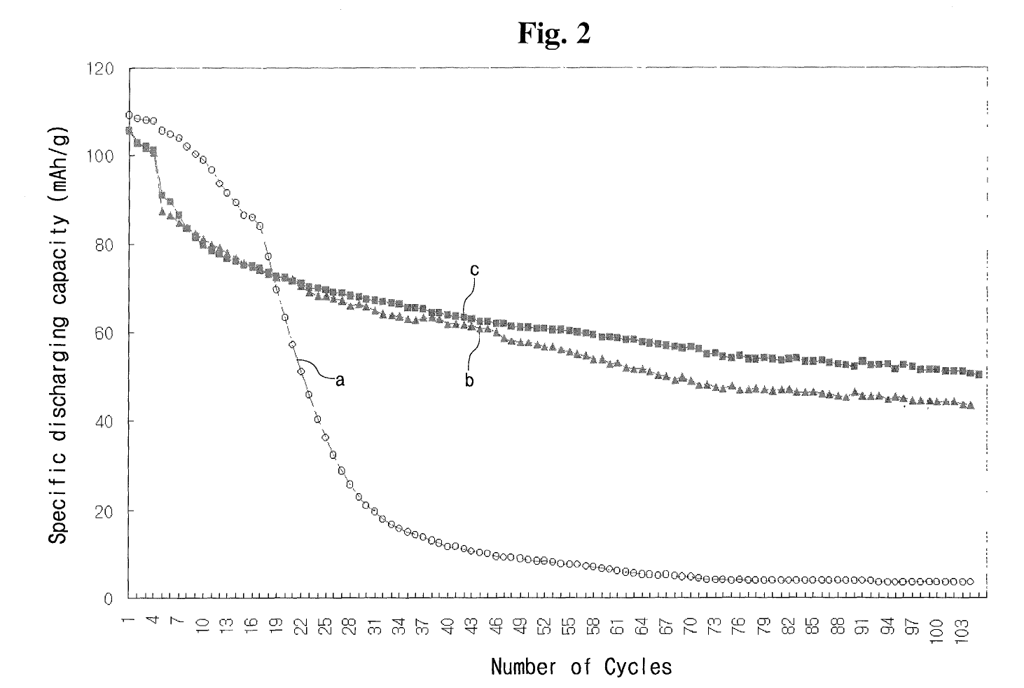

The cycle life characteristics of coin cells comprising positive active material of Examples 1 and 5 and Comparative Example 2 at elevated temperature were measured and are shown in FIG. 2. As can be seen from FIG. 2, coin cells (b and c) using the positive active material according to Examples 1 and 5 have better cycle life characteristic at elevated temperature (60) than battery (a) using the positive active material of Comparative Example 2.

Accordingly, the present invention provides a method of coating conductive polymer on the surface of lithium complex metal oxides used as positive active material. With this method, it is easy to coat and evenly coat conductive polymer. The prepared positive active material has excellent electrochemical characteristics, particularly at elevated temperatures.

What is claimed is:

1. A method of preparing positive active material for a lithium secondary battery comprising:
preparing a coating solution by dissolving a conductive polymer in a solvent; and
coating lithium complex metal oxide with the coating solution.

2. The method of claim 1, wherein said coating step is carried out by using an agglomerator or a spray dryer.

3. The method of claim 1, wherein said conductive polymer is selected from the group consisting of polypyrrole, polyaniline, polythiophene, polyacetylene, derivatives thereof, and mixtures thereof.

4. The method of claim 3, wherein said conductive polymer is emeraldine base or a polymer in doping state.

5. The method of claim 1, wherein said coating solution further comprises a conductive agent.

6. The method of claim 1, wherein said coating solution further comprises a conductive agent and an ionic conductive polymer.

7. The method of claim 6, wherein said ionic conductive polymer is selected from the group consisting of polyethylene oxide, polypropylene oxide, polyethylene glycol, derivatives thereof, salts thereof and mixtures thereof.

8. The method of claim 1, wherein said lithium complex metal oxide is selected from the group consisting of LiₓMn_{1-y}M′_{y}A₂, LiₓMn_{1-y}M′_{y}O_{2-z}A_{z}, LiₓMn₂O_{4-z}, LiₓMn_{2-y}M′_{y}A₄, LiₓM_{1-y}M″_{y}A₂, LiₓMO_{2-z}A_{z}, LiₓNi_{1-y}Co_{y}O_{2-z}, LiₓNi_{1-y-z}Co_{y}M″_{z}Aα, and LiₓNi_{1-y-z}Mn_{y}M′_{z}Aα, wherein 0.95≦x≦1.1, 0≦y≦0.5, 0≦z≦0.5, 0<α≦2, M is Ni or Co, M′ is at least one element selected from the group consisting of Al, Ni, Co, Cr, Fe, Mg, Sr, V, Sc, Y, La, Ce, Pr, Nd, Pm, Sm, Eu, Gd, Tb, Dy, Ho, Er, Tm, Yb, Lu, Ac, Th, Pa, U, Np, Pu, Am, Cm, Bk, Cf, Es, Fm, Md, No, and Lr, M″ is at least one element selected from the group consisting of Al, Cr, Mn, Fe, Mg, Sr, V, Sc, Y, La, Ce, Pr, Nd, Pm, Sm, Eu, Gd, Tb, Dy, Ho, Er, Tm, Yb, Lu, Ac, Th, Pa, U, Np, Pu, Am, Cm, Bk, Cf, Es, Fm, Md, No, and Lr, and A is selected from the group consisting of O, F, S and P.

9. The method of claim 8, wherein said lithium complex metal oxide is selected from the group consisting of LiₓMn_{1-y}M′_{y}A₂. LiₓMn_{1-y}M′_{y}O_{2-z}A_{z}, LiₓMn₂O_{4-z}A_{z}, and LiₓMn_{2-y}M′_{y}A₄

10. The method of claim 1, wherein the amount of coated conductive polymer ranges from 1 to 30 wt % based on the weight of the lithium metal oxide.

11. The method of claim 1, wherein the amount of coated conductive polymer ranges from 1 to 10 wt % based on the weight of the lithium metal oxide.

12. The method of claim 1, wherein the lithium complex metal oxide is coated with the coating solution to form a coating layer having a thickness ranging from 0.1 to 1 μm.
